(19) United States
(12) Patent Application Publication
(10) Pub. No.: US 2008/0028843 A1
(43) Pub. Date: Feb. 7, 2008

(54) Method for Detection of Valve Opening Timepoints of Fuel Injection Systems of an Internal Combustion Engine

(76) Inventors: Roland Dietl, Regensburg (DE); Oliver Kastner, Donaustauf (DE); Hans-Peter Rabl, Kelheim (DE); Udo Reilander, Rieden/a.F. (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/833,822

(22) Filed: Aug. 3, 2007

(30) Foreign Application Priority Data
Aug. 4, 2006 (DE) 10 2006 036 568.2

(51) Int. Cl. G01M 19/00

(52) U.S. Cl. 73/118.1

(57) ABSTRACT

A measured current, voltage or capacity characteristic is subtracted from an idealized characteristic line of the same size stored in the system. The maxima, minima and reversal points are identified in this calculated difference curve, since these values correlate to the valve opening timepoints. In another step the values determined in the first step are approximated in respect of a target value situated on the difference curve with the aid of a mathematical method, in order to ascertain a more exact determination of these values.

### CROSS-REFERENCE TO RELATED APPLICATIONS

This application claims priority to German Patent Application Number 10 2006 036 568.2 filed on Aug. 4, 2006, and which is incorporated herein by reference in its entirety.

### TECHNICAL FIELD

The present application relates to fuel injection systems and methods to operate fuel injection systems.

### BACKGROUND

In automotive engineering use is made in injection systems, e.g. the common-rail, of piezo injectors for injecting fuel into the combustion chambers. When piezo injectors are used for injection into the combustion chambers the mechanical attributes of the injection apparatus mean that a systematic error can occur. Because of manufacturing tolerances in the aforementioned components, different amounts of fuel are supplied to the combustion chambers even though the control duration and actuator energy are the same. In turn, the different amounts of fuel result in a different power output from the respective combustion chambers, which in addition to an increase in irregular running also cause an increase in the amount of harmful exhaust gas components. Manufacturing tolerances can also bring about changes in the opening behavior of piezo injectors. This is apparent in that the start of hydraulic injection between the individual piezo injectors as well as the injection discharge rate are different.

A method is known from the prior art which forms a difference curve from the current characteristic and/or voltage characteristic and/or capacity characteristic measured on the piezo injector and an idealized characteristic line stored in the system, which has the same measured variable as the characteristic line measured at the piezo injector. This idealized characteristic line represents the case in which the piezo injector is operated without external load. The difference curve calculated here has characteristic values in the course of the curve, e.g. maximum, minimum or reversal point, which correlate with the valve opening timepoints. The characteristic values cannot be determined exactly, since the difference curve is determined not only by the manufacturing tolerances, but also by other parameters.

### SUMMARY

A more exact and precise method for detecting the opening timepoint of fuel injection systems can be provided by a method for detection of the valve opening timepoint of a fuel injection system of an internal combustion engine, comprising the steps of determining a difference curve between a measured voltage characteristic and/or current characteristic and/or capacity characteristic and an idealized characteristic line which has the same measured variable as the characteristic line measured at a piezo injector, wherein the idealized characteristic line represents the situation in which no external load acts on the piezo injector, and wherein with respect to the difference curve a characterizing value corresponding to a maximum and/or minimum and/or reversal point on the difference curve is identified within a predefined curve region, and starting from the characterizing point situated on the difference curve, applying a mathematical method in order to approximate the characterizing value within the difference curve in respect of a target value occurring on the difference curve.

### BRIEF DESCRIPTION OF THE DRAWINGS

Details of the invention are described further on the basis of the drawings, in which:

FIG. 1: shows a method for more exact determination of the characterizing value of the difference curve shape,

FIG. 2: shows the temporal capacity shapes for the measured and the idealized characteristic line for different bias voltages with predefined valve opening times,

FIG. 3: shows the temporal capacity shape for the measured and the idealized characteristic line for different bias voltages with exact determination of the characterizing value.

### DETAILED DESCRIPTION

In a first step, a difference curve is measured from the measured current characteristic and/or voltage characteristic and/or capacity characteristic. The difference curve is obtained by subtracting the measured characteristic line from an idealized characteristic line. This idealized characteristic line has the same measured variable as the characteristic line measured at the piezo injector and is stored in the system. It represents the case in which the piezo actuator is operated without external load. A characteristic line can also be stored which corresponds qualitatively to the behavior without load, but quantitatively is supported with scaling factors to the measured values.

The shape of the difference curve has, depending on the measured characteristic line, a rough positioning of at least one value characterizing the characteristic line. This characterizing value can here be e.g. a maximum and/or minimum and/or a reversal point and correlates with the valve opening timepoints. A characterizing value is then determined in a predefined region after the piezo injector has been supplied with power. The region to be considered must be selected such that it has a characterizing value. Hence the characterizing value is not considered until after a predefined period from the time power is supplied to the piezo injector. It has proved advantageous here because of the measured capacity shape of the piezo injector to determine the characterizing value in the region between the second and third intersection point of the measured and of the idealized curve.

However, an exact determination of the characterizing value cannot take place in this step, since the curve shape of the difference curve still depends on other factors. A direct determination of the characterizing value solely on the basis of the measured characteristic lines is also associated with uncertainty because of the limited number of measurement points.

According to an embodiment, a more exact determination of the characterizing value determined in the first step takes place in a second step. The characterizing value is approximated in respect of a target value occurring in the difference curve shape. Any mathematical methods which describes the curve shape (e.g. linear, polynomial, logarithmic) is suitable for this. For reasons of computational capacity and computational time, the curve shape is only approximated to a predefined precision within a predefined interval, around the characterizing value determined in the first step.

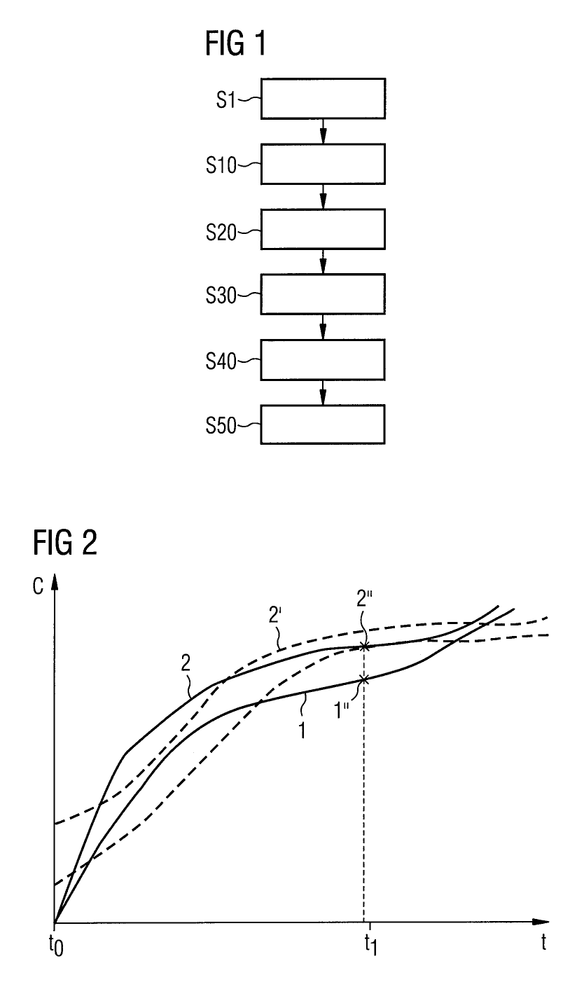

In FIG. 1 the piezo actuator is controlled by an electrical signal in step S1. In step S20 the current characteristic and/or voltage characteristic and/or capacity characteristic measured in step S10 is subtracted from an idealized characteristic line of the same measured variables which is stored in the system.

In step S30 a characterizing value is roughly identified in a predefined region from the difference curve determined in step S20. In this case the region is for example between the second and third intersection between the measured and the idealized characteristic line.

A more exact determination of the characterizing value determined in step S30 takes place in step S40. The starting point for consideration is the roughly determined characterizing value situated on the difference curve. Within a predefined interval range this value is approximated in respect of a target value occurring in the difference curve, this target value here being a maximum and/or a minimum and/or a reversal point.

The regulation of the valve opening timepoint in step S50 takes place with the aid of the characterizing value determined more exactly in step S40.

FIG. 2 shows the temporal capacity shape for the measured and idealized characteristic line at different bias voltages at a piezo actuator. In this embodiment the opening timepoint of the piezo injector is permanently predefined

The continuous curve shapes 1 and 2 in both cases here represent the measured capacity shapes, and the dashed curve shapes 1′ and 2′ represent the idealized capacity shapes, the bias voltage for capacity shape 2 being less than the bias voltage for capacity shape 1.

In both cases the piezo-actuator is excited with a voltage at timepoint t0 until timepoint t1. Timepoint t1 corresponds here to the values 1∴ and 2″ on the respective capacity curve.

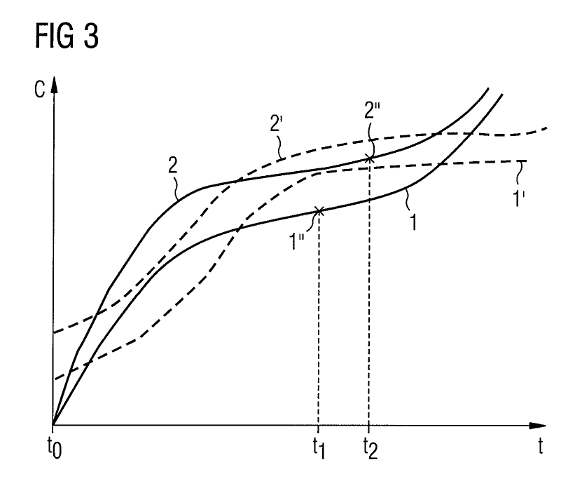

FIG. 3 shows the temporal capacity shapes for the measured and the idealized characteristic line for different bias voltages with exact determination of the characterizing values. All reference characters correspond to those in FIG. 2.

The characterizing values 1″ and 2″ are calculated after the method referred to in FIG. 1. In this case the valve opening timepoint t1 for capacity shape 1 is earlier, from a temporal perspective, than the valve opening timepoint t2 for capacity shape 2.

What is claimed is:

1. A method for detection of the valve opening timepoint of a fuel injection system of an internal combustion engine, comprising the steps of:
determining a difference curve between a measured voltage characteristic and/or current characteristic and/or capacity characteristic and an idealized characteristic line which has the same measured variable as the characteristic line measured at a piezo injector, wherein the idealized characteristic line represents the situation in which no external load acts on the piezo injector, and wherein with respect to the difference curve a characterizing value corresponding to a maximum and/or minimum and/or reversal point on the difference curve is identified within a predefined curve region, and
starting from the characterizing point situated on the difference curve, applying a mathematical method in order to approximate the characterizing value within the difference curve in respect of a target value occurring on the difference curve.

2. The method according to claim 1, wherein the approximation takes place within a predefined search region around the characterizing value of the difference curve.

3. The method according to claim 1, wherein the mathematical approximation method is a linear, polynomial, logarithmic or exponential approximation method.

4. A method for detection of the valve opening timepoint of a piezo injector, comprising the steps of:
determining a difference curve between a measured voltage characteristic and/or current characteristic and/or capacity characteristic and an idealized piezo injector characteristic line, wherein the idealized characteristic line represents the situation in which no external load acts on the piezo injector,
identifying, with respect to the difference curve a characterizing value corresponding to a maximum and/or minimum and/or reversal point on the difference curve within a predefined curve region, and
starting from the characterizing point situated on the difference curve, applying a mathematical method in order to approximate the characterizing value within the difference curve in respect of a target value occurring on the difference curve.

5. The method according to claim 4, wherein the approximation takes place within a predefined search region around the characterizing value of the difference curve.

6. The method according to claim 4, wherein the mathematical approximation method is a linear, polynomial, logarithmic or exponential approximation method.

7. A fuel injection system comprising
a piezo injector,
means for determining a difference curve between a measured voltage characteristic and/or current characteristic and/or capacity characteristic and an idealized piezo injector characteristic line, wherein the idealized characteristic line represents the situation in which no external load acts on the piezo injector,
means for identifying, with respect to the difference curve a characterizing value corresponding to a maximum and/or minimum and/or reversal point on the difference curve within a predefined curve region, and
means for starting from the characterizing point situated on the difference curve, applying a mathematical method in order to approximate the characterizing value within the difference curve in respect of a target value occurring on the difference curve.

8. The system according to claim 7, wherein the approximation takes place within a predefined search region around the characterizing value of the difference curve.

9. The system according to claim 7, wherein the mathematical approximation method is a linear, polynomial, logarithmic or exponential approximation method.
